(19) United States
(12) Patent Application Publication
(10) Pub. No.: US 2006/0279182 A1
(43) Pub. Date: Dec. 14, 2006

(54) Assembleable and detachable metal storage cabinet

(76) Inventor: Eric Yim Chi Ming, Kowloon (HK)

Correspondence Address: Michael D. Yablonsky;Law Office of Sergei Orel, 660 Anderson Ave., Cliffside Park, NJ, 07010, US

(21) Appl. No.: 11/450,838

(22) Filed: Jun. 9, 2006

(30) Foreign Application Priority Data
Jun. 10, 2005 (HK) 05104895.3

(51) Int. Cl. E05B 65/46

(52) U.S. Cl. 312/219

(57) ABSTRACT

An assembleable and detachable metal storage cabinet, comprising: a metal housing holding a different number of drawers and a plurality of drawers slidable in the metal housing. 3/16″ screws and bolts are used to connect a drawer front panel to a drawer left side panel and a drawer right side panel to form a drawer, and used to connect a base frame, a rear panel, a left side panel, a right side panel and a top cover to form a metal housing. Besides, pulling pegs are used to connect a drawer bottom panel, a drawer rear panel, a drawer left side panel and a drawer right side panel to form a basis of the drawer. In this way, a firm, assembleable and detachable metal storage cabinet can be formed. Additionally, a new lock system, which is composed of a welded structural lock frame, is installed in this metal storage cabinet to forbid the drawers being concurrently pulled out. According to the metal storage cabinet of the present invention, besides a firm metal material is used, the entirety of the cabinet can be detached into parts of smaller sizes to be conveniently delivered into an office having a narrow doorway.

### TECHNICAL FIELD

The present invention relates to a metal storage cabinet, particularly to an assembleable and detachable metal storage cabinet.

### BACKGROUND ART

A metal storage cabinet is chiefly a storage device made of a metal, and is comprised of a metal housing and a set of cabinets containing a plurality of drawers so long as an outer rail inside the metal housing is connected to an inner rail outside the drawers such that the drawers can travel along the rails to an extent that they are drawn out. In addition, there is provided lock means for locking all the drawers. There are two possibilities according to the prior art: one is that the metal storage cabinet consists of an integrated metal housing and a set of cabinets containing a plurality of drawers, wherein the number of drawers depends on the number of rails. But this design exhibits a drawback: as the metal housing of the metal storage cabinet is of an integrated design so that during transport thereof, as often seen, it is costly to ship and store large-size storage cabinet and very difficult to deliver a large-size storage cabinet to an office having a narrow doorway such that the procedures of delivery become more difficult or even some offices are deprived of using large-size metal storage cabinets, thereby causing inconvenience.

Besides, the other design, targeting the aforesaid drawback, allows each part of the storage device to be assembled in an assembleable and detachable form so that the storage device can be adapted to an office having a narrow doorway. However, according to the technology at that time, the storage device can only be made of a nonmetal material such as fiberglass, wood or plastics. In this case, whilst the storage device according to the design solves a problem, it derives another problem, that is, as such materials are not so firm as a metal, the resultant storage device deforms for lack of enough bearing force to support heavy files in the office and becomes not durable.

### SUMMARY OF THE INVENTION

In view of the above problems, an object of the present invention is to provide an assembleable and detachable metal storage cabinet, wherein besides that the metal storage cabinet can be made of a firm metal material, it can be wholly detached into parts of smaller sizes to be conveniently delivered into an office having a narrow doorway and then to be assembled again into a storage cabinet.

To reach the above object, the present invention provides an assembleable and detachable metal storage cabinet, comprising: a metal housing holding a different number of drawers, the metal housing comprising: a base frame and four adjustable legs disposed on the bottom of the metal housing, the base frame having at each of the four corners a triangle metal plate adjustable leg threaded hole for screwing the adjustable leg in; a rear panel on the back; a left side panel on the left and a right side panel on the right, the right side panel being substantially the same as and disposed in mirror symmetry with the left side panel; a welded structural lock frame disposed on the front side, the lock frame having on the left and right sides thereof a same number of outer rail stops, outer rail snap holes and lock frame recesses, the lock frame having at the central top position thereof a lock hole; a lock catch movable connection shaft disposed in the top edge of the lock frame; a lock frame movable lock rod disposed on the two sides of the lock frame; a top cover located at the top portion of the metal housing; a set of lock means comprising a lock head, a key, and a lock head retaining means; a plurality of outer rails disposed on said lock frame and the left and right side panels; and a plurality of drawers slidable in the metal housing, the drawer comprising: a drawer bottom panel disposed on the bottom of the drawer; a drawer left side panel located on the left side of the drawer and a drawer right side panel located on the right side of the drawer, the drawer right side panel being substantially the same as and disposed in mirror symmetry with the drawer left side panel; a drawer rear panel disposed on the back of the drawer, the rear panel being of a rectangular shape and having on the left and right sides a plurality of nail holes for connecting other drawer side panels; a drawer front panel disposed on the front side of the drawer and assembled on the perimeter formed by a drawer right side panel outer edge, a drawer left side panel outer edge and a drawer bottom panel vertical edge; a label disposed within a drawer handle; an anti-collision rubber mounted in an anti-collision rubber snap hole; a plurality of inner rails disposed on the drawer left and right side panels; a plurality of transverse hangers disposed on the top portion of the drawer; a plurality of longitudinal hangers disposed on the top portion of the drawer; and a plurality of cylindrical pulling peg.

The present invention can provide an assembleable and detachable metal storage cabinet, wherein besides that the metal storage cabinet can be made of a firm metal material, it can be wholly detached into parts of smaller sizes to be conveniently delivered into an office having a narrow doorway and then to be assembled again into a storage cabinet such that a large-size metal storage cabinet can also used in an office having a small and narrow doorway. This also reduces the cost of shipment and storage of the aforesaid metal storage cabinet.

### BRIEF INTRODUCTION OF DRAWINGS

FIG. 1 is a three-dimensional schematic view showing the appearance of the assembleable and detachable metal storage cabinet according to the present invention;

FIG. 2 is an exploded view of the metal storage cabinet of FIG. 1;

FIG. 3 is an exploded view of the drawer of the metal storage cabinet as shown in FIG. 2;

FIG. 4 is an exploded view of the metal housing of the metal storage cabinet as shown in FIG. 2;

FIG. 5 is a top view of the rear panel of the metal housing of FIG. 4;

FIG. 6A and FIG. 6B are three-dimensional schematic views of left and right side panels of the metal housing of FIG. 4;

FIG. 7 is a three-dimensional schematic view of the welded structural lock frame of the metal housing of FIG. 4;

FIG. 8 is a three-dimensional schematic view of a set of lock means within the top edge of the lock frame of FIG. 7;

FIG. 9 is a front view of the lock catch movable connection shaft within the top edge of the lock frame of FIG. 7;

FIG. 10 is a three-dimensional schematic view of the lock frame movable lock rod in the left edge of the lock frame of FIG. 7;

FIG. 11 is a three-dimensional schematic view of the lock frame movable lock rod in the right edge of the lock frame of FIG. 7;

FIG. 12 is a three-dimensional schematic view of the outer rail mounted on the right side panel and the right edge of the lock frame as shown in FIGS. 6B and 7;

FIG. 13 is a three-dimensional schematic view of the outer rail mounted on the left side panel and the left edge of the lock frame as shown in FIGS. 6A and 7;

FIG. 14 is a side view of the drawer front panel of the drawer of FIG. 3;

FIG. 15 is a three-dimensional schematic view of the label in the drawer front panel of FIG. 14;

FIGS. 16A and 16B are three-dimensional schematic views of the inwardly facing surface and the outwardly facing surface of the drawer left side panel of the drawer as shown in FIG. 3;

FIGS. 17A and 17B are three-dimensional schematic view of the outwardly facing surface and the inwardly facing surface of the drawer right side panel of the drawer as shown in FIG. 3;

FIG. 18 is a three-dimensional schematic view of the back surface of the inner rail mounted on the drawer left side panel of FIG. 16A;

FIG. 19 is a three-dimensional schematic view of the front surface of the inner rail mounted on the drawer right side panel of FIG. 17A;

FIG. 20 is a three-dimensional schematic view of an anti-collision rubber of the drawer of FIG. 3;

FIG. 21 is a three-dimensional schematic view of a transverse hanger of the drawer of FIG. 3;

FIG. 22 is a three-dimensional schematic view of a longitudinal hanger of the drawer of FIG. 3;

FIG. 23 is a three-dimensional schematic view of an adjustable leg of the metal housing of FIG. 4;

FIG. 24 is a three-dimensional schematic view of a bolt 3/16″ according to the present invention;

FIG. 25 is a three-dimensional schematic view of a screw 3/16″ according to the present invention;

FIG. 26 is a three-dimensional schematic view of a pulling leg according to the present invention;

FIG. 27 is a side view of the metal storage cabinet in the use state according to the present invention;

FIGS. 28A-28EE are views showing the assembling procedure of the metal storage cabinet according to the present invention;

FIG. 29 is a three dimensional schematic view of the metal storage cabinet according to the second embodiment of the present invention.

### MODES OF CARRYING OUT THE INVENTION

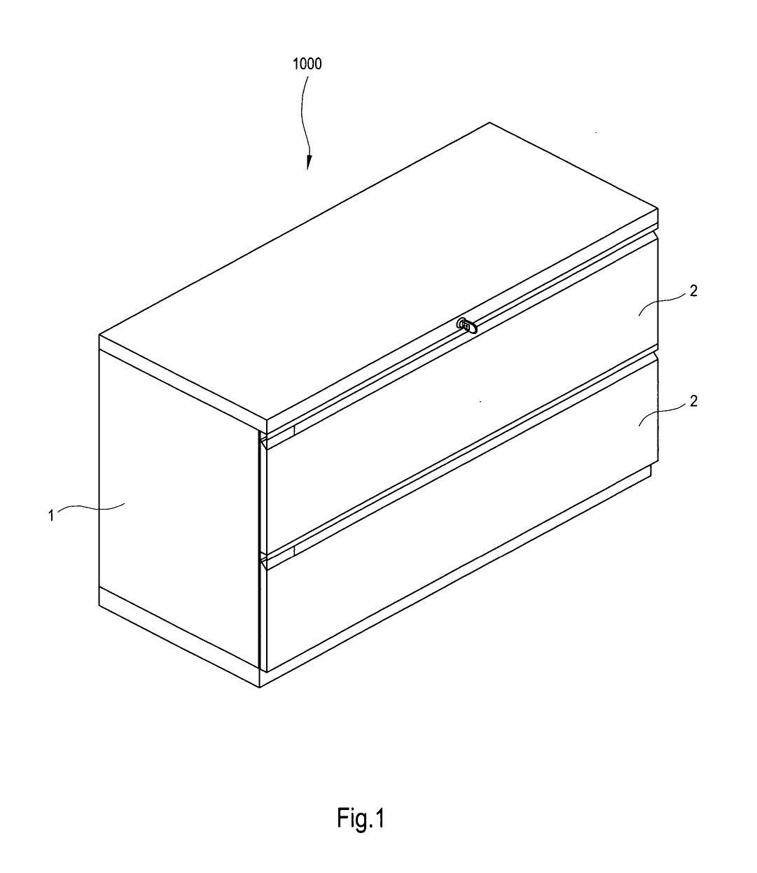

First referring to FIG. 1, FIG. 1 is a three-dimensional schematic view of an assembleable and detachable metal storage cabinet 1000 according to an embodiment of the present invention, comprising: a metal housing 1 for receiving two drawers 2 and two drawers slidable in the metal housing 1.

Then referring to FIG. 2, FIG. 2 is an exploded view of the metal storage cabinet 1000 according to the present invention, showing all the assemblies of the metal housing 1 for receiving two drawers 2 and the two drawers 2 slidable in the metal housing 1.

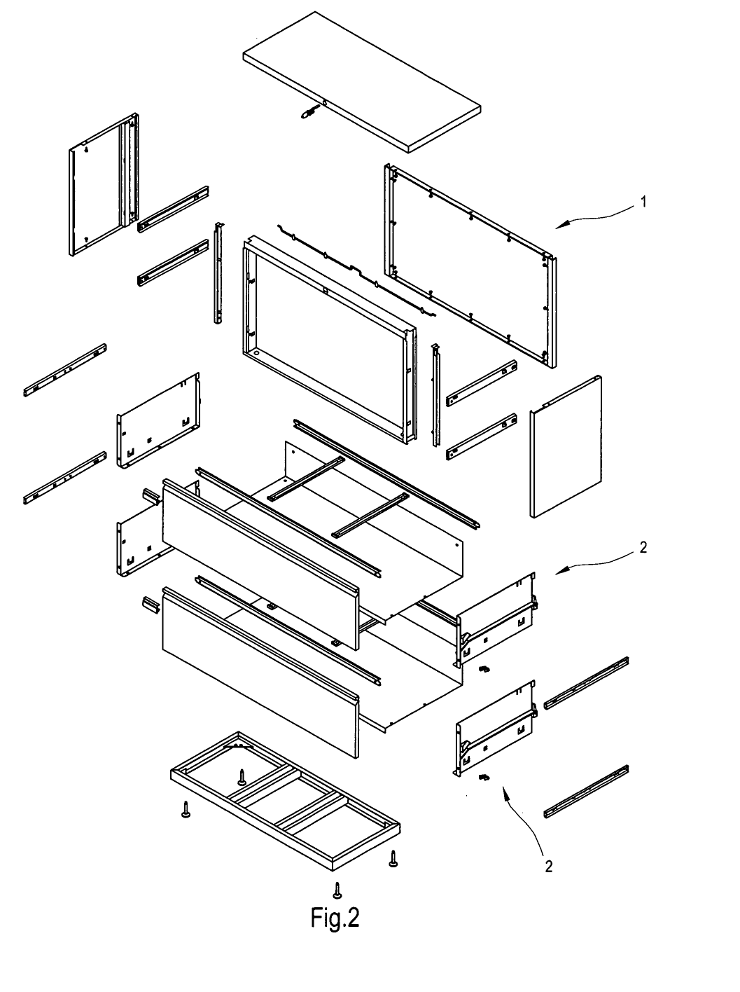

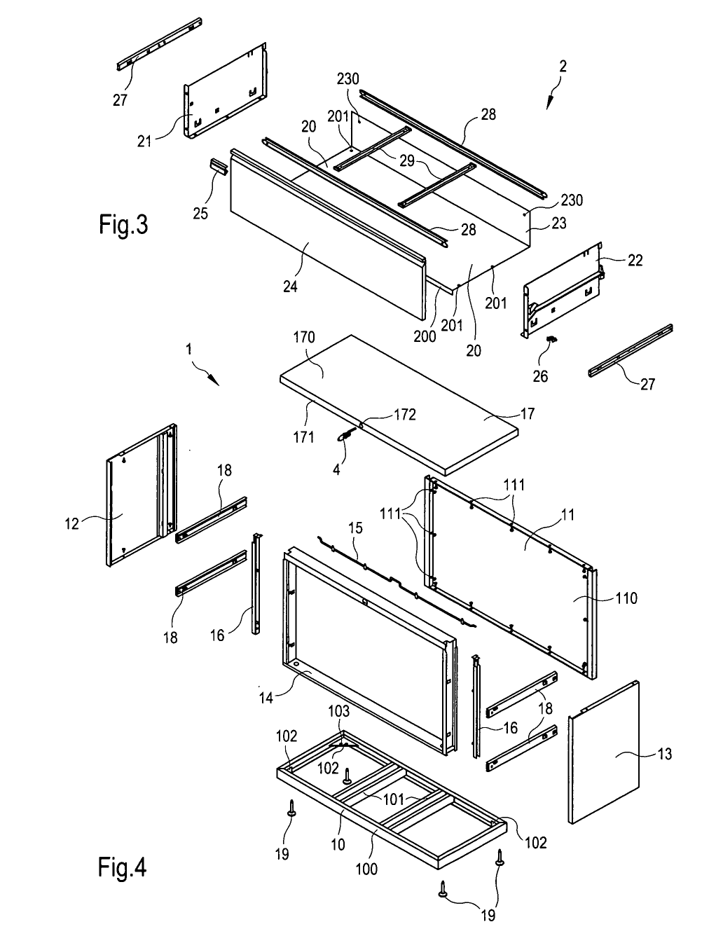

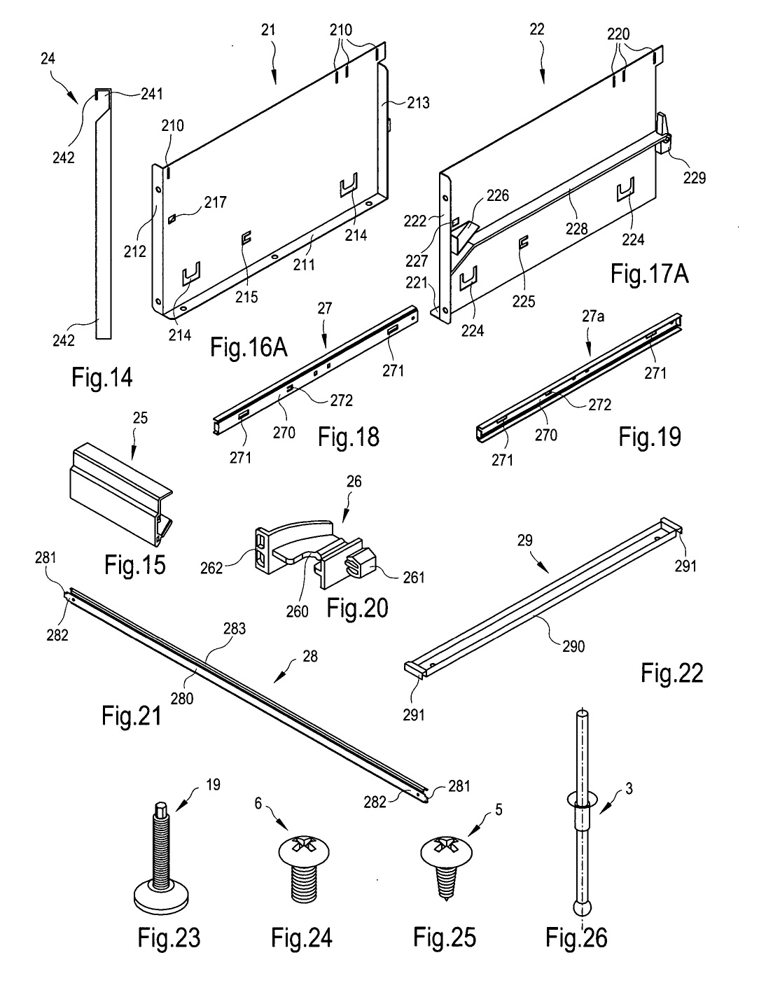

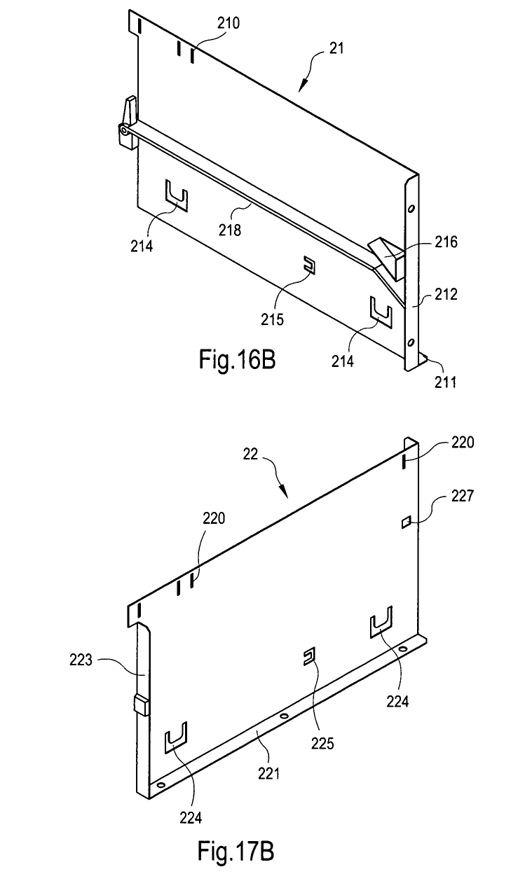

FIG. 3 is an exploded view of the drawer 2 of the metal storage cabinet 1000 according to the present invention. The Figure shows the arrangement of ten assemblies of the drawer 2, comprising: a bottom panel 20 disposed at the bottom of the drawer 2 and being in a rectangular shape and provided on both sides with a plurality of nail holes 201 for connection to other side panels of the drawer, the bottom panel 20 being provided at the front facing edge with a downwardly hanging vertical edge 200; a drawer left side panel 21 located on the left of the drawer 2; a drawer right side panel 22 located on the right of the drawer 2 and substantially disposed in mirror symmetry relative to the left side panel 21; a drawer rear panel 23 disposed on the back of the drawer 2, the rear panel 23 being in a rectangular shape and provided on left and right sides thereof with a plurality of nail holes 230 for connection to other drawer side panels; a drawer front panel 24 disposed on the front side of the drawer 2 and rightly assembled on the perimeter formed by a drawer right side panel outer edge 222 (see FIG. 17A), a drawer left side panel outer edge 212 (see FIG. 16A) and a drawer bottom panel vertical edge 200; a label 25 (see FIG. 15) provided in a front panel recess 241 (see FIG. 14) within a drawer handle 242 (as shown in FIG. 14); an anti-collision rubber mounted in an anti-collision rubber snap hole 217, 227 (see FIGS. 16A and 17A); two inner rails 27, 27A respectively disposed on the drawer left and right side panels 21 and 22, the front sides of the inner rails 27, 27A being connected to the front sides of the outer rails 18 of the metal housing 1, and the back sides of the inner rails 27, 27A being connected to the drawer left and right side panels 21 and 22; a plurality of transverse hangers 28 and longitudinal hangers 29 disposed on the top portion of the drawer 2, the above ten assemblies assembled into one drawer 2 of the metal storage cabinet 1000.

The referring to FIG. 4, FIG. 4 is an exploded view of the metal housing 1 of the metal storage cabinet 1000. The figure shows the arrangement of ten assemblies of the metal housing 1 and one lock means 4 therein, comprising: a base frame 10 and four adjustable legs 19 disposed on the bottom of the metal housing 1, the base frame 10 having a rectangular outer frame 100 and having near the central position two base frame supports 101 connected to upper and lower edges thereof and having at each of the four corners a substantially triangular metal plate 102, the metal plate being provided with an adjustable leg threaded hole 103 for threading the adjustable leg 19 in as the basis of the metal storage cabinet 1000; a rear panel 11 located on the back of the metal housing 1, the rear panel 11 having a rectangular rear panel base 110 provided at its perimeter with a plurality of screw holes 111; a left side panel 12 located on the left of the metal housing, the left side panel 12 having a rectangular left side panel base 120 (see FIG. 6A) and an inwardly extending flange 121 (see FIG. 6A), the upper and lower flanges provided thereon with a plurality of screw holes 122 (see FIG. 6A); a right side panel 13 located on the right of the metal housing 1 and substantially disposed in mirror symmetry relative to the left side panel 12; a lock frame 14 mounted on the front side of the metal housing 1 and clamped in the lock frame receiving openings 126 (see FIG. 6A) and 136 (see FIG. 6B) of the left and right side panels 12 and 13; an elongate lock catch movable connection shaft 15 disposed on the top edge of the lock frame 14; protrusions 151 (see FIG. 9) at the left and right ends of the lock catch movable connection shaft 15 connected downwardly to a lock frame movable lock rod 16 disposed on the two sides of the lock frame 14; a top cover 17 disposed on the top of the metal housing 1, the top cover 17 having a rectangular metal panel 170, the perimeter of the top cover extending downwardly and rightly covering the perimeter of the metal housing 1 formed by the lock frame 14, left and right side panels 12 and 13 and the rear panel 11, a top cover front flange 171 of the top cover 17 facing the front being in a “U” shape and provided at a central position of the top cover front flange 171 with a hole 172, just overlapping a lock hole 144 (see FIG. 7) of the lock frame 14 for assembly of the lock means 4; four outer rails 18 disposed on the lock frame 14 and left and right side panels 12 and 13, wherein two rails are in mirror symmetry with the other two rails and respectively mounted on the left and right sides, the front sides of the outer rails 18 being connected to the back sides of the inner rails 27 of the drawer 2, and oppositely the back sides of the outer rails 18 being connected to outer rail snap holes 142 and 125, 135 on the lock frame 14 and the left and right side panels 12 and 13, the above ten assemblies being assembled into the metal housing 1 of the metal storage cabinet 1000. At last, a set of lock means 4 is disposed in said lock hole 144 (see FIG. 7) and is comprised of a lock head 41 (see FIG. 8), a key 40 (see FIG. 8) and a lock head retaining means 42 (see FIG. 8).

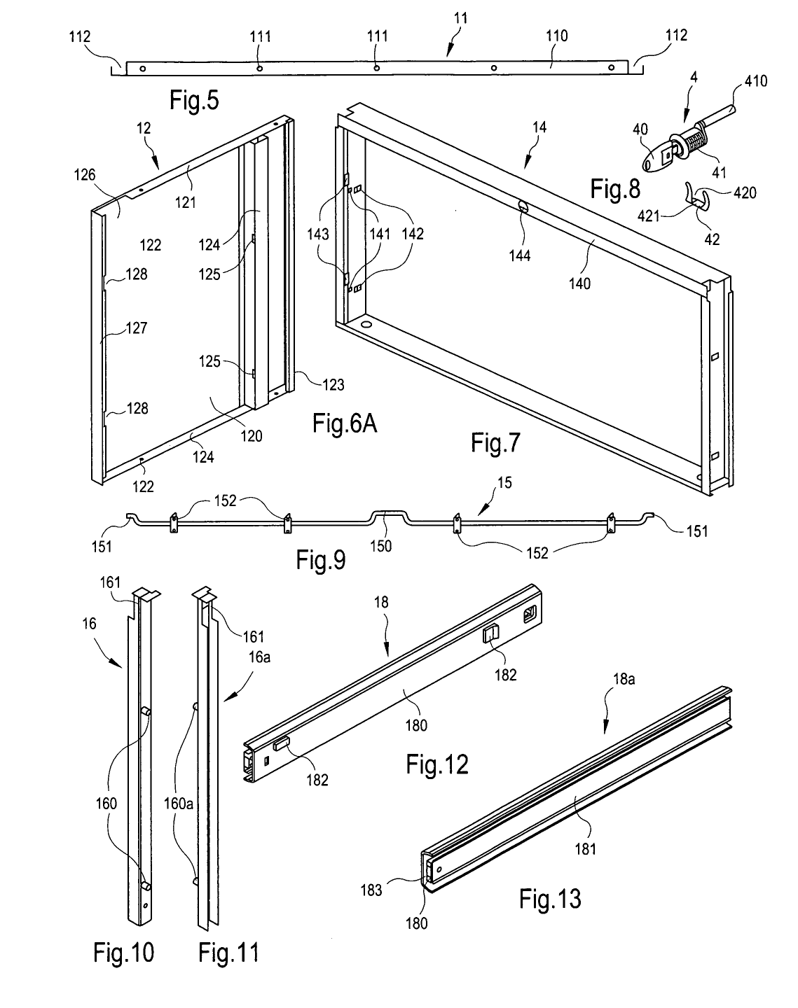

Then referring to FIG. 5, the figure shows a top view of the rear panel 11 on the back of the metal housing 1, the rear panel 11 having a rectangular rear panel base 110 which upper edge is provided with a plurality of screw holes 111 and the edges of the left and right ends thereof are in an asymmetrical “U” shape with the outwardly facing end being relatively shorter and are called “U”-shaped edges 112 of the rear panel for cooperating with a barb-shaped left side panel right barbed flange 123 and a barb-shaped right side panel left barbed flange 133 respectively on the left and right side panels 12 and 13 for the assembly purpose.

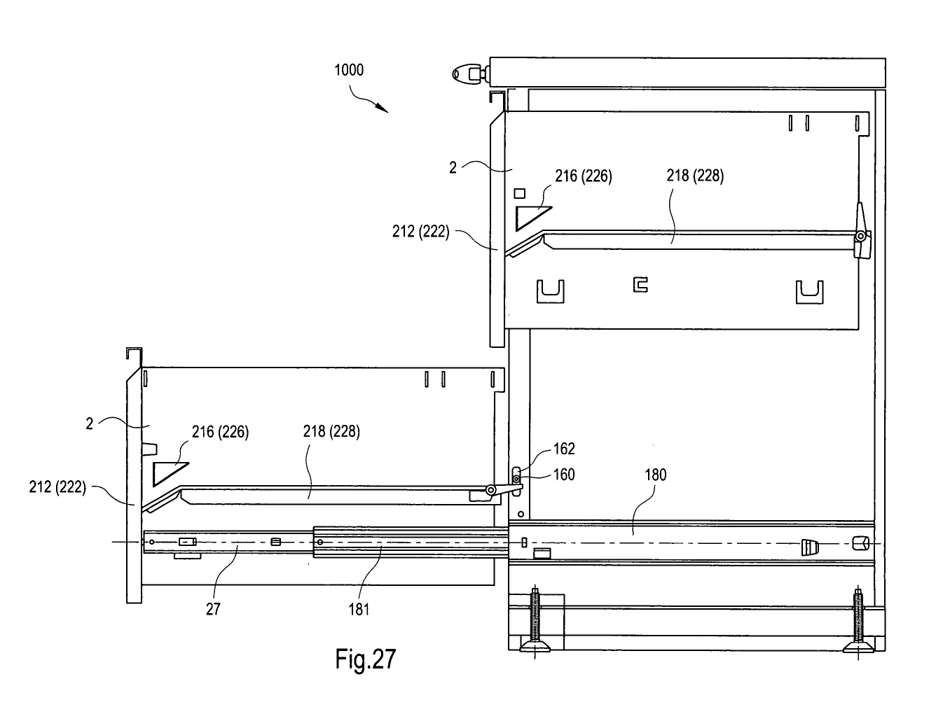

Then referring to FIGS. 6A and 6B, the two figures respectively show the left side panel 12 on the left of the metal housing 1 and the right side panel 13 on the right of the metal housing 1, wherein the right side panel 13 is substantially disposed in mirror symmetry relative to the left side panel 12. The left and right side panels 12 and 13 respectively have rectangular left and right side panel bases 120, 130 and inwardly extending flanges 121, 131, and the upper and lower flanges 121, 131 are provided with a plurality of screw holes 122, 132 for connecting other panels of the metal housing 1. Now taking the left side panel 12 in FIG. 6A as example, the edge of the right end thereof extends to form a barb-shaped left side panel right barbed flange 123 to cooperate with the rear panel “U”-shaped edge 112 of the rear panel 11 for the purpose of assembly. The panel base 120 near the right end is provided with a protruding platform 124 on which are provided a plurality of outer rail snap holes 125 to receive one of outer rail snap bodies 182 of the outer rail 18 for stability purpose. Besides, there is provided a nick called as lock frame receiving opening 126 at the upper portion near the left end to enable the lock frame 14 (see FIG. 7) to be assembled between the left and right side panels 12 and 13. The tail portion of the left end extends to form a barb shape called left side panel left barbed flange 127 on which are provided two left side panel recesses 128 forming a lock bar movement groove 162 (see FIG. 27) together with lock frame recesses 143 (see FIG. 7) to allow a lock frame movable lock bar 160 (see FIGS. 10 and 11) to move therein. When it is the right side panel 13, the edge at the left end is a right side panel left barbed flange 133, the panel base 120 near the left end is provided with a protruding platform 134 on which are provided a plurality of outer rail snap holes 135, a lock frame receiving opening 136 is provided at the upper portion near the right end, and the tail portion of the right end extends to form a barb shape called right side panel right barbed flange 137 on which are provided a plurality of right side panel recesses 138 configured and functioning completely the same as the aforesaid left side panel 12.

Now referring to FIG. 7, the figure shows a welded structural lock frame 14 disposed to the front side of the metal housing 1 and rightly clamped in the lock frame receiving holes 126, 136 of the left and right side panels 12, 13, the lock frame having a rectangular outer frame 140 and provided on each of the left and right sides with two outer rail stops 141, outer rail snap holes 142 and lock frame recesses 143, wherein the stops 141 each are a metal sheet on the inner edge of two sides of the lock frame 14 that can be raised and can more reinforce the positions of the outer rails 18, wherein the snap holes 142 are holes in the inner edge of two sides of the lock frame 14 to allow one of the outer rail snap bodies 182 on the outer rail 18 to be firmly mounted therein, and wherein the lock frame recesses 143 together with the left and right side panel recesses 128, 138 form a lock bar movement groove 162 (see FIG. 27) to allow a lock frame movable lock bar 160 (see FIGS. 10 and 11) to move therein. On the other hand, there is provided with a lock hole 144 at a central position of the top edge of the lock frame 14 for mounting the lock means 4 therein.

The referring to FIG. 8, the figure shows a set of lock means 4 disposed in a lock hole 144 and comprised of a lock head 41, a key 40 and a lock head retaining means 42. The lock head retaining means 42 has a substantially rectangular base plate 421, wherein one edge of the base plate 421 extends upwardly respectively from the left and right sides to form a lock head retaining means recess 420 for securing the circular lock head 41. In addition, the circular lock head 41 is provided at the distal end with a lock head movable bar 410 and located at one point of the circular perimeter such that when the key 40 brings the lock head 41 into rotation, the lock head movable bar 410 revolves about the circle center of the lock head 41, thereby bringing a protruding catch 150 (see FIG. 9) of the connection shaft in contact wherewith to ascend or descend.

Now referring to FIG. 9, the figure shows and elongate lock catch movable connection shaft 15 disposed in the top edge of the lock frame 14, wherein the protruding catch 150 of the connection shaft in the middle of the connection shaft 15 is rightly concealed at a position within the lock hole 144, and wherein the two ends of the connection shaft 15 both bend outwardly to form left and right protrusions 151 of the connection shaft in such a manner as to synchronically ascend or descend when the protruding catch 150 of the connection shaft is brought by the lock head movable bar 410 to ascend or descend so as to control vertical ascent or descent of the lock frame movable lock rod 16 connected to the left and right protrusions 151 of the connection shaft. At last, four connection shaft retaining pieces 152 equally distributed between the protruding catch 150 and the left and right protrusions 151 are all of a rectangular shape and function to fasten the lock catch movable connection shaft 15 to the interior of the top edge of the lock frame 14.

Then referring to FIGS. 10 and 11, they respectively show a lock frame movable lock rod 16, 16a disposed in both sides of the lock frame 14, each of the movable lock rods 16, 16a provided with two lock frame movable lock bars 160, 160a engaging in a lock bar movement groove 162 (see FIG. 27) formed by the lock frame recess 143 and the left and right side panel recesses 128, 138. As above discussed, the rotation of the lock head 41 can indirectly control the vertically ascending or descending action of the lock frame movable lock bars 16, 16a so that the two lock frame movable lock bars 160, 160a can vertically ascend or descend in the lock bar movement groove 162 (see FIG. 27).

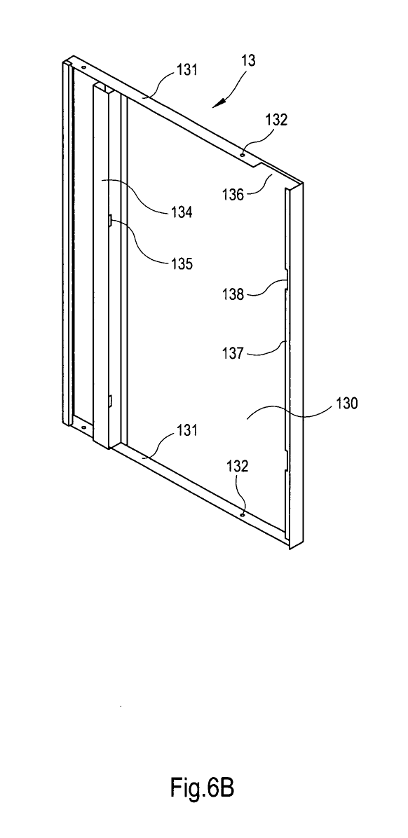

Now referring to FIGS. 12 and 13, the figures show two outer rails 18 and 18a respectively disposed in said lock frame 14 and the left and right side panels 12 and 13, wherein the outer rails 18 and 18a include two segments, and they are of an elongate and recessed configuration called an outer rail outer housing 180 and an outer rail inner housing 181, the entire outer rail inner housing 181 can be disposed in and move in an outer rail outer housing recess 183, their mutual movement is realized by means of the body of the outer rail inner housing 181 assembled to a steel ball sliding means in the outer rail outer housing recess 183 so that the outer rail 18 can be extended and retracted as desired such that the drawers, after being assembled, can be drawn out or pushed in. On the back side of the outer rail outer housing 180 is provided two protruding outer rail snap bodies 182 respective tightly snap fitted in outer rail snap holes 142 and 125, 135 on the lock frame 14 and the left and right side panels 12 and 13 so as to reach the snap fitting effect.

Now referring to FIG. 14 showing a drawer front panel 25 disposed on the front side of the drawer 2 and assembled on the perimeter formed by a drawer left side panel outer edge 212 (see FIG. 16A), an drawer right side panel outer edge 222 (see FIG. 17A), and the vertical edge 200 of the drawer bottom panel, wherein the body of the drawer front panel 24 is substantially of a rectangular shape and its perimeter is a two-layered metal sheet frame 240, the upper portion of the metal sheet frame 240 is provided on the outwardly facing side with a front panel recess 241 that slants upwardly and inwardly in such a manner that the upper edge of the metal sheet frame 240 forms a downwardly barbed shape acting as a drawer handle 242 and that the recess can receive a label 25 (see FIG. 15).

Now referring to FIG. 15 showing a label 25 assembled in the drawer handle 242, the cross-sectional shape of the drawer handle is completely compliant with the label 25 so that the label 25 can be rightly disposed in the drawer handle 242 and a user can more easily distinguish articles or files in the drawer.

Now referring to FIGS. 16A, 16B and 17A, 17B showing the inner and outer edges of a drawer left side panel 21 and the outer and inner edges of a drawer right side panel 22, wherein the left side panel 21 extends inwardly at the bottom to form a drawer left side panel bottom edge 211 for connecting the drawer bottom panel 20, the front end of the left side panel extends outwardly to form a drawer left side panel outer edge 212 for connecting the drawer front panel 24 and the rear end of the left side panel extends inwardly to form a drawer left side panel inner edge 213 for connecting the drawer rear panel 23, respectively. The above three edges are provided with a plurality of nail holes for mounting purpose. Likewise, as the right side panel 22 is substantially arranged the same as the left side panel 21, the right side panel 22 extends inwardly at the bottom to form a drawer right side panel bottom edge 221 for connecting the drawer bottom panel 20, the front end of the right side panel extends outwardly to form a drawer right side panel outer edge 222 for connecting the drawer front panel 24 and the rear end of the right side panel extends inwardly to form a drawer right side panel inner edge 223 for connecting the drawer rear panel 23, respectively. The above three edges are provided with a plurality of nail holes for mounting purpose. Besides, the drawer left and right side panels 21, 22 are provided at the middle lower portion thereof with two inner rail snap holes 214, 224 for snap fitting with the inner rail snap body 271 (see FIGS. 18 and 19) on the inner rail 27, and inner rail stops 215, 225 in the central position at the same level of the drawer left and right side panels 21, 22 are each a metal sheet that can be outwardly raised and run through the inner rail stop receiving hole 272 for snap fitting so as to reaching the snap fitting effect. There is provided with a movable lock bar stop 216, 226 adjacent to the central position of the said drawer left side panel 21. As the lock frame movable lock bar 160, brought by the lock head 41, ascends to rightly enter a position between the movable lock bar stop 216, 226 and the drawer left and right side panel outer edge 212, 222, the drawer 2 cannot be pulled out even if it is drawn forcefully at this time. There is provided above the stop 216, 226 with an anti-collision rubber snap hole 217, 227 for snap fitting with the anti-collision rubber 26; there is provided beneath the stop 216, 226 with a movable lock bar guide rail 218, 228 having a small portion adjacent to the outer edge ascending slantwise upwardly and a major portion inside extending straight so that when the drawer is drawn, said lock frame movable lock bar 160 travels along the movable lock bar guide rail 218, 228, whereby more than one drawer 2 cannot be concurrently pulled out. This function will be specified when FIG. 27 is described. Besides, there is provided at the distal end of the movable lock bar guide rail 218, 228 with a rotatable guide rail end movable piece 219, 229 which is vertical when the drawer 2 is not pulled out and which, when the drawer 2 is pulled out to the extremity, will be driven by said lock frame movable lock bar 160 to rotate to be in alignment with and connection with said movable lock bar guide rail 218, 228, thereby becoming an extension of the movable lock bar guide rail 218, 228. At last, there are provided on the top edges of the drawer left and right side panels 21, 22 with a plurality of upright hanger mounting gaps 210, 220 for mounting the transverse hangers 28 therein.

Now referring to FIGS. 18 and 19 showing a back side of the inner rail 27a mounted on the left side panel 21 and a back side of the inner rail 27a mounted on the right side panel 22, wherein the front sides of the inner rails 27, 27a are connected to the front sides of the outer rails 18, 18a, the elongate recessed configuration allows the entire inner rail 27, 27a to be disposed in and move in the outer rail inner housing recess 181, and their mutual movement is realized by means of the inner rail body 270 assembled to a steel ball sliding means in the outer rail inner housing recess 181. Conversely, the back sides of the inner rails 27, 27a are connected to the outer sides of the drawer left and right side panels 21, 22 in such a manner that the inner rail snap bodies 271 on the inner rails 27, 27a are connected to the inner rail snap holes 214, 224 on the drawer left and right side panels 21, 22 and the outwardly raised inner rail stops 215, 225 enter the stop receiving holes 272 on the inner rails 27, 27a for snap fitting purpose and effect.

FIG. 20 shows a three-dimensional schematic view of an anti-collision rubber 26 mounted in the anti-collision rubber snap holes 217, 227. Said anti-collision rubber 26 is connected via an anti-collision rubber snap body 261, and an anti-collision rubber body 260 is dimensioned in such a manner that an anti-collision rubber piece 262 protruding from the outer end of the anti-collision rubber 26 is disposed at the inward position on the left and right of the metal sheet frame 240. When the drawer 2 is completely closed, said anti-collision rubber piece 262 is clamped between the metal sheet frame 240 and a outer frame of the lock frame 14 in such a manner as to absorb a portion of shock and impact when a user closes the drawer 2 with an excessive force to avoid the damage of the metal storage cabinet 1000.

Now referring to FIGS. 21 and 22 respectively showing a transverse hanger 28 disposed on the top portion of the drawer 2 and a longitudinal hanger 29 disposed thereon, the transverse hanger 28 is mounted in a manner that hanger mounting lugs 281 outwardly protruding from the left and right ends of the transverse hanger 28 are inserted into said hanger mounting gaps 210, 220. The lower part of the hanger mounting lug 281 is slightly inwardly indented but slightly beyond the transverse hanger body 280, and it is called a hanger retaining lug 282. In this manner, the distance between the hanger retaining lugs 282 on the left and right ends is right the width of the interior of the drawer 2. In addition, the transverse hanger 28 body is provided with an upwardly extending protruding edge called a transverse hanger rail 283 into which longitudinal hanger legs 291 at the front and rear ends of the longitudinal hanger body 290 is mounted so that the longitudinal hanger 29 can transversely side along the transverse hanger 28 for flexibly hanging suspended-type files of different specifications.

Now referring to FIGS. 23-26, the figures show different component parts from different angles. FIG. 23 shows an adjustable leg 19 disposed on the uttermost bottom portion of the metal housing 1, screwed in an adjustable leg threaded hole 103 in a triangular metal plate 102 at each of the four corners of a base frame 10, and functioning as the basis of the metal storage cabinet 1000. FIGS. 24 and 25 show a 3/16″ screw 5 and a bolt 6 used at many places of connection of the metal housing 1, wherein they are used to connect the drawer front panel 24 to the drawer left side panel 21 and the drawer right side panel 22 to form the drawer 2, and they are used to connect the base frame 10, the rear panel 11, the left side panel 12, the right side panel 13 and the top cover 17 to form the metal housing 1. At last, FIG. 26 shows a pulling peg 3 for connecting the drawer bottom panel 20, the drawer rear panel 23, the drawer left side panel 21 and the drawer right side panel 22, wherein the pulling peg has a body in a cylindrical shape with a protruding means in the central position so as to function to lock two panels.

Now referring to FIG. 27, the figure shows the use state of the metal storage cabinet 1000. The preceding figures have already described the basic operation of the metal storage cabinet 1000 according to the present invention. FIG. 27 aims to describe in detail the reason why more than one drawer 2 cannot be concurrently pulled out according to the present invention. When the metal storage cabinet 1000 is not locked, the two lock frame movable bars 160 on the lock frame movable lock rod 16 are at the uttermost bottom position of the lock bar movement groove 162. When a user draws any one of the drawers 2, the lock frame movable lock bar 160 ascends along the movable lock bar guide rail 218, 228. As both of the lock frame movable lock bars 160 are on the same lock frame movable lock rod 16, the other lock frame movable lock bar 160 will synchronically ascend so as to enter a position between the movable lock bar stop 216, 226 and the drawer left and right side panel outer edge 212, 222 and so that even if another drawer 2 is drawn forcefully at this time, it cannot be opened.

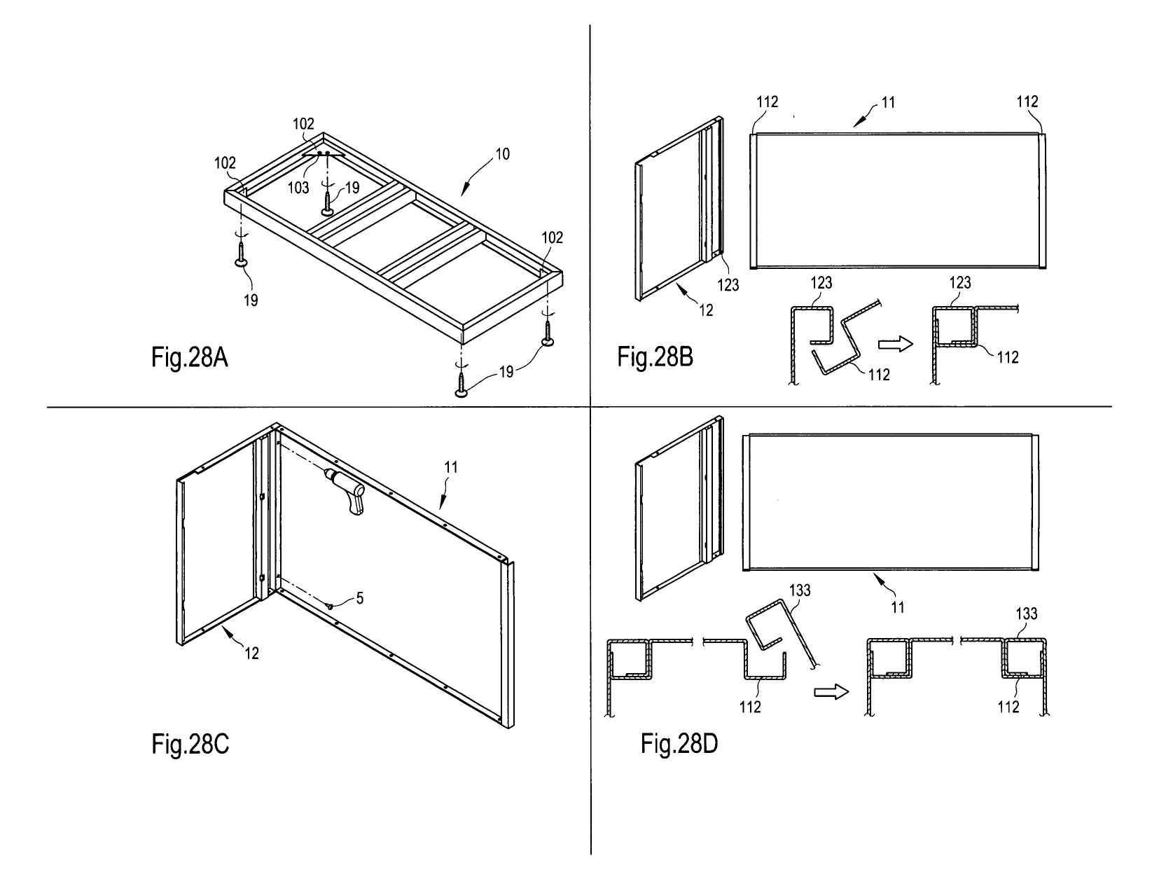

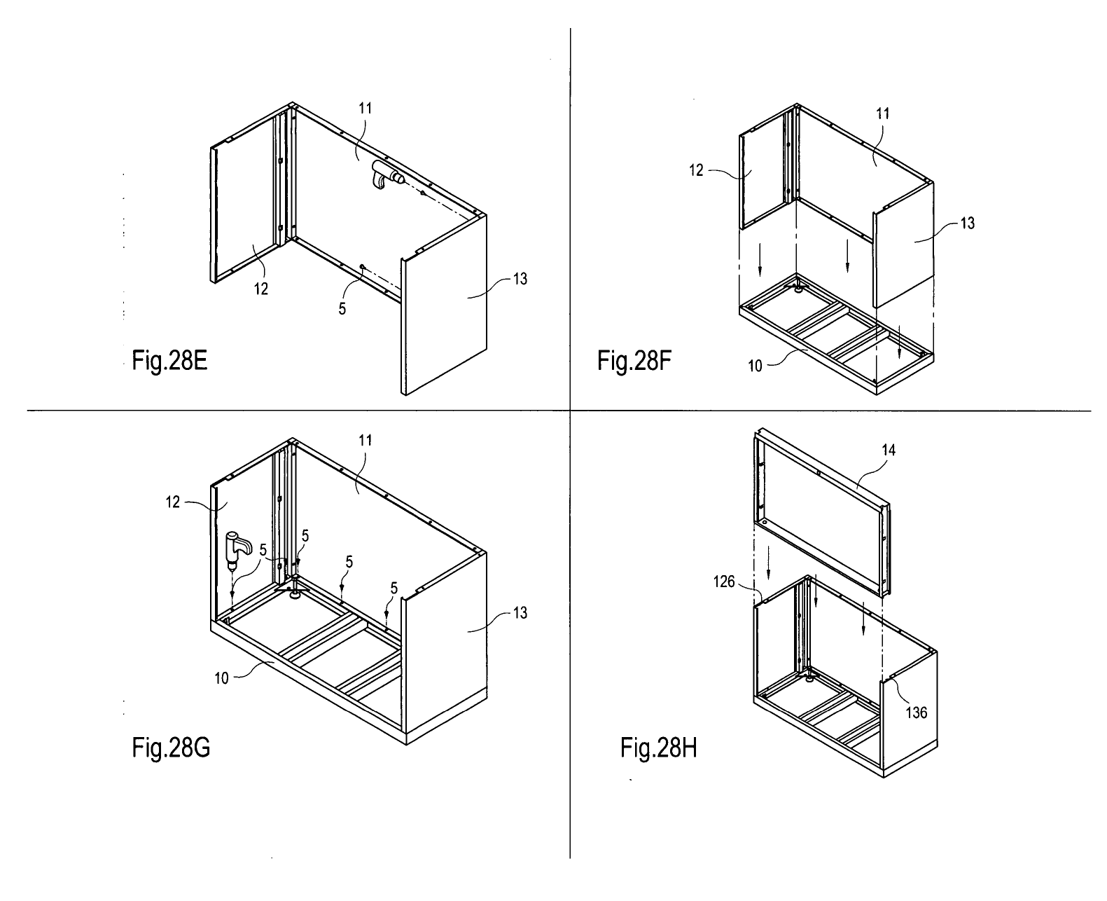

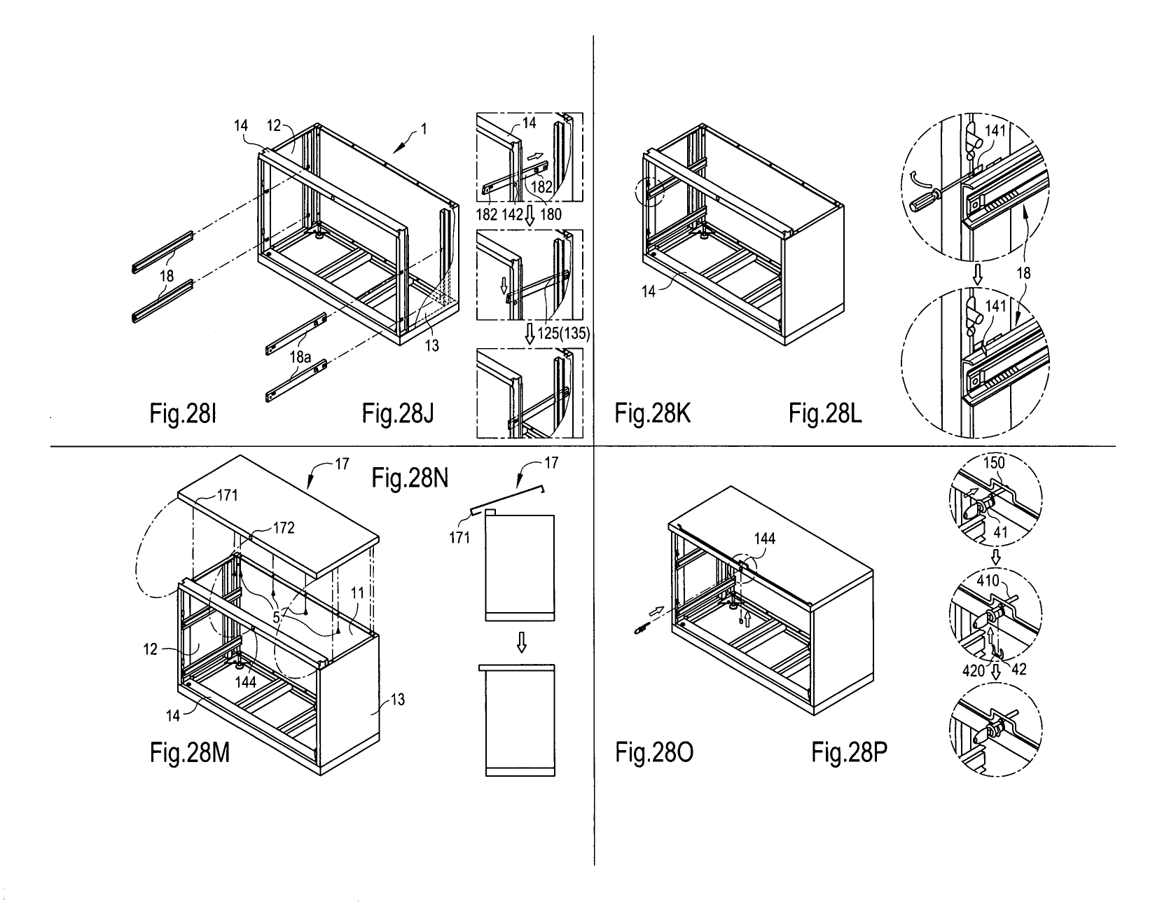

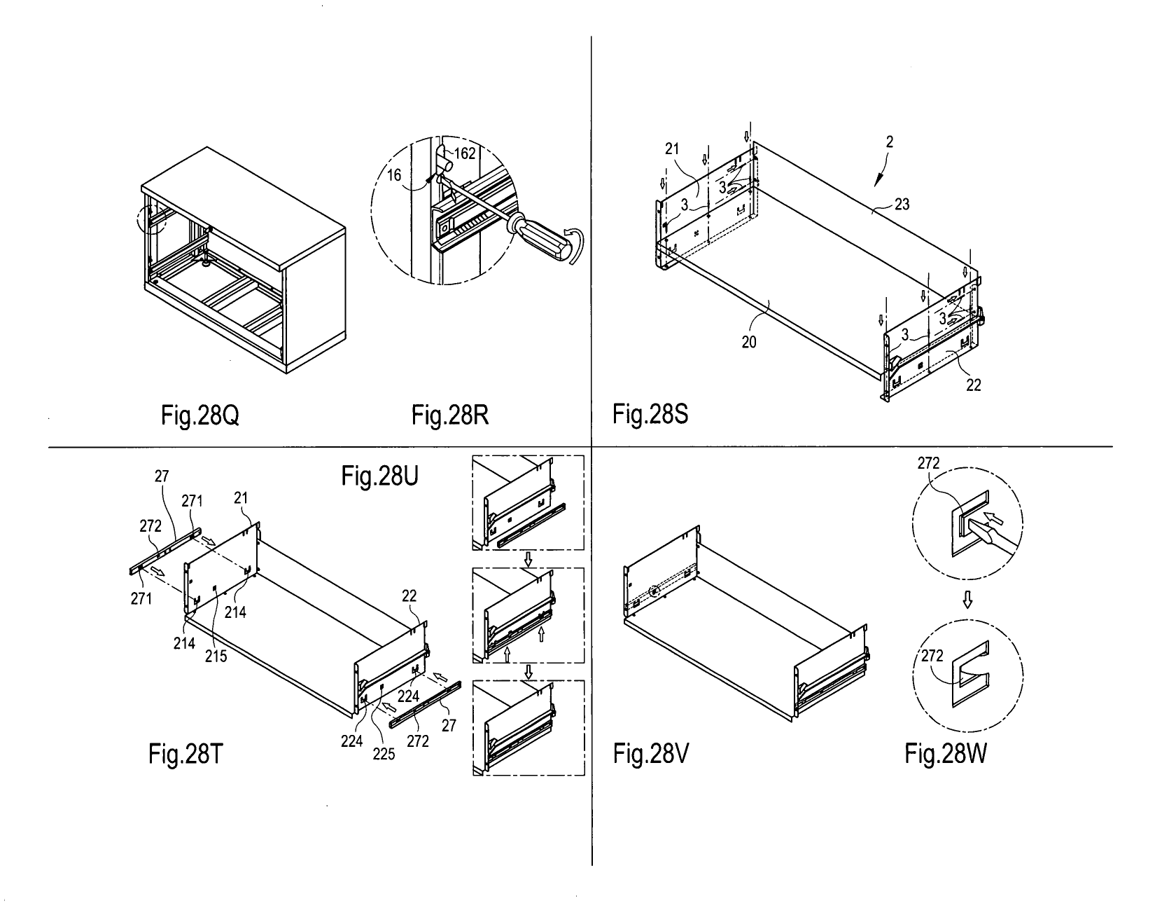

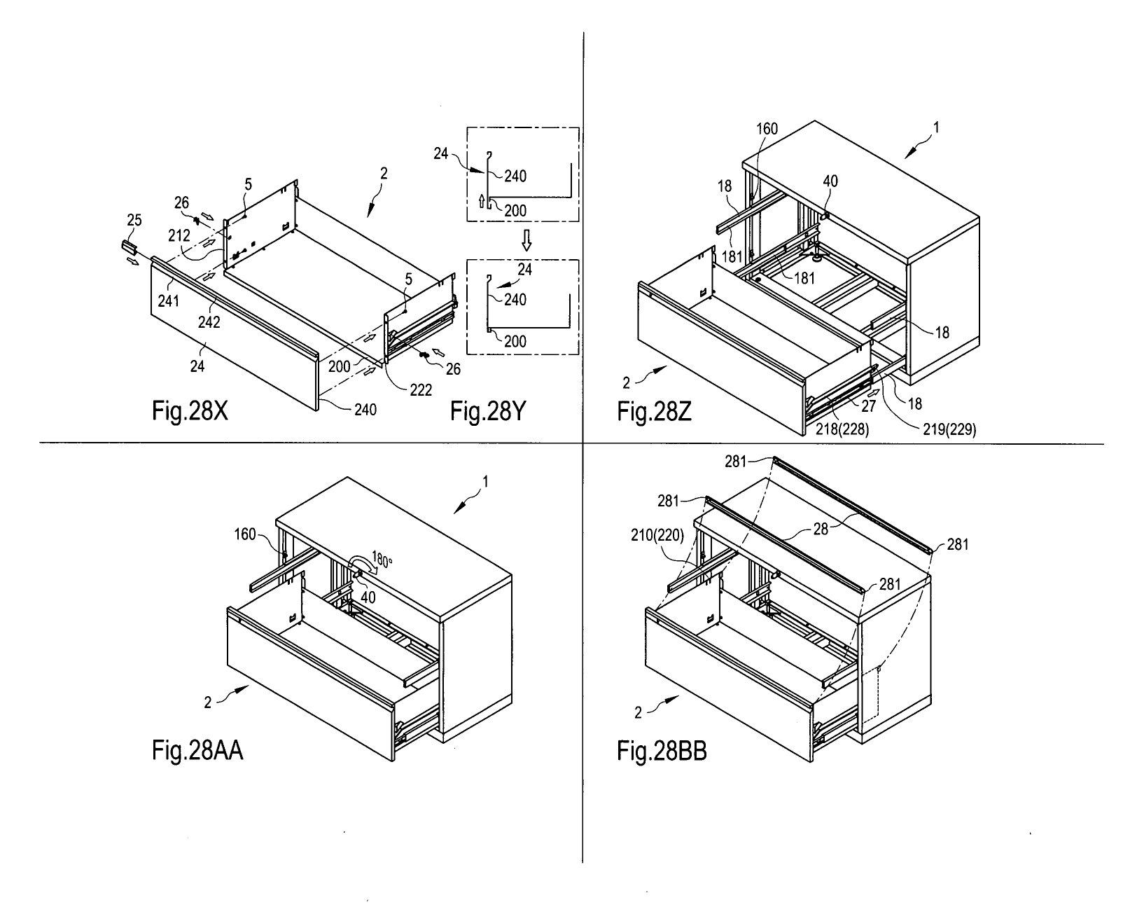

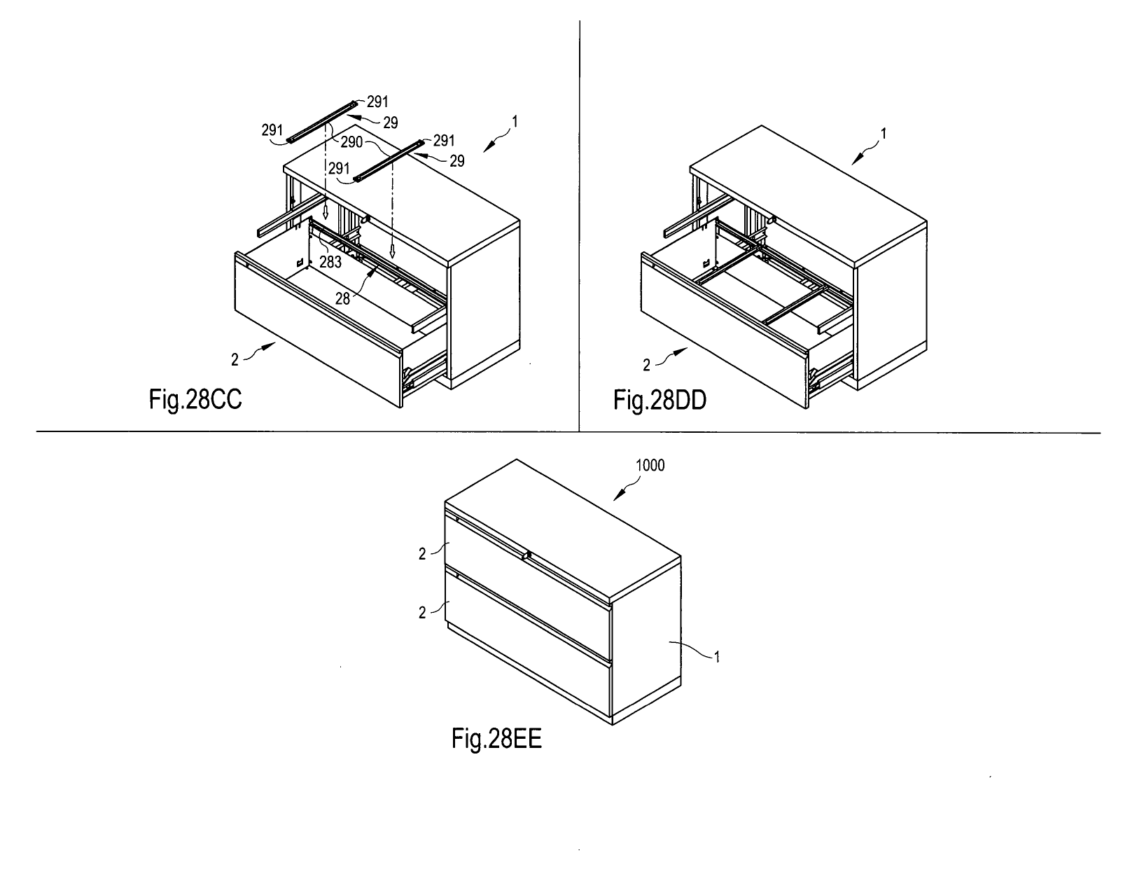

FIGS. 28A-28EE are series of figures showing the assembling procedure and briefly show how the metal storage cabinet 1000 according to the present invention is assembled. FIG. 28A shows that the four adjustable legs 19 on the uttermost bottom portion are screwed in the adjustable leg threaded holes 103 on the triangular metal plates 102 at the four corners of the base frame 10 and act as the basis of the metal storage cabinet 1000. FIG. 28B and FIG. 28C show the situation when the left side panel 12 is connected to the rear panel 1,1. It can be seem from FIG. 28B that the rear panel “U”-shaped edges 112 of the edges of the left and right ends of the rear panel 11 cooperates with a barb-shaped left side panel rear barbed flange 123 of the left side panel 12 for mounting purpose and then they are fastened with 3/16″ screws 5. FIG. 28D and FIG. 28E show the situation when the right side panel 13 is connected to the rear panel 11. It can be seen from FIG. 28D that the rear panel “U”-shaped edge 112 of the edges of the left and right ends of the rear panel 11 cooperates with a barb-shaped right side panel rear barbed flange 133 of the right side panel 13 for mounting purpose and then they are fastened with 3/16″ screws 5. FIG. 28F and FIG. 28G show the situation when the connected left and right side panels 12, 13 and the rear panel 11 that are connected together are wholly assembled on the base frame 10, wherein their connection is by means of locking via 3/16″ screws 5. FIG. 28H shows the situation when the lock frame 14 is assembled into the lock frame receiving holes 126, 136 between the left and right side panels 12 and 13 in such a manner that the lock frame 14 is firmly disposed in the outer edge of the metal housing 1. FIG. 28I-FIG. 28L show that the situations when four outer rails 18, 18a are respectively mounted on said lock frame 14 and the left side panel 12 and the lock frame 14 and the right side panel 13. It can be seen from FIG. 28J that the two outer rail snap bodies 182 on the back side of the outer rail outer housing 180 respectively tightly snap with the outer rail snap holes 142, and 125 and 135 on the lock frame 14 and the left and right side panels 12 and 13 to reach a snap fitting effect. After the outer rails 18, 18a are duely mounted, as shown in FIG. 28L that the outer rail stop body 141 will be prized to become a metal sheet rising towards the inner edge of the lock frame 14 so as to reinforce the positions of the outer rails 18, 18a. FIG. 28M shows the situation when the top cover 17 is placed on said metal housing 1, wherein the top cover 17 is provided with a front flange 171 extending downwardly and rightly covering the peripheral edge of the metal housing 1 formed by the lock frame 14, the left and right side panels 12 and 13 and the rear panel 11, and then 3/16″ screws 5 are used for locking purpose. A hole 172 is provided at a central position of the front flange 171 of the top cover and rightly overlaps with the lock hole 144 in the lock frame 14 for mounting the lock means 4. It can be seen from FIG. 28N that the front flange 171 of the top cover is in a “U” shape that makes the connection firmer. FIG. 28O shows the situation when the lock means 4 is assembled into the lock hole 144. It can be seen from FIG. 28P that when the circular lock head 41 enters the lock hole 144, the lock head movable bar 410 will support the protruding catch 150 of the connection shaft, then the lock head retaining means 42 is embedded upwardly from beneath by virtue of the lock head retaining means recess 420 to completely secure the lock head 41. FIG. 28Q is a view showing removal of the fix screw of the lock frame movable lock rod 16. It can be seen from FIG. 28R that after the fix bolt is removed, the lock frame movable lock rod 16 can freely move upwardly and downwardly in the lock bar movement groove 162. FIG. 28S shows the situation when the drawer bottom panel 20, the drawer rear panel 23, the drawer left side panel 21 and the drawer right side panel 22 are connected via the pulling pegs 3 to form a drawer 2. FIG. 28T and FIG. 28W show the situation when the two inner rails 27, 27a are respectively mounted on the outer sides of the drawer left and right side panels 21, 22. It can be seen from FIG. 28U that the back sides of the inner rails 27, 27a are connected to the outer sides of the drawer left and right side panels 21, 22 in such a manner that the inner rail snap bodies 271 on the inner rails 27, 27a are snap fitted upwardly in the inner rail snap holes 214, 224 on the drawer left and right side panels 21, 22 and then the inner rail stops 215, 225 are pushed outwardly by using a tool into the stop receiving holes 272 on the inner rails 27 for the sake of snap fitting purpose and effect. FIG. 28X shows the situation when the drawer front panel 24 is covered to the drawer 2, wherein the drawer front panel 24 has a metal sheet frame 240 covering and being fastened via 3/16″ screw 5 to the perimeter formed by the drawer right side panel outer edge 222, the drawer left side panel outer edge 212 and the vertical edge 200 of the drawer bottom panel. It can be seen from FIG. 28Y that the bottom edge of the metal sheet frame 240 is in an upwardly barbed shape and rightly snap fits with the vertical edge 200 of the drawer bottom panel so that the connection and supporting are made more secure and stable. On the other hand, the anti-collision rubber 26 is connected by snap fitting the anti-collision rubber snap body 261 into the anti-collision rubber snap hole 217, 227, and the label 25 is mounted in the front panel recess 241 of the drawer handle 242. FIG. 28Z shows that the entire drawer 2 is mounted in the metal housing 1, wherein the front side of the inner rails 27, 27a is connected to the front side of the outer rail 18, 18a, the elongate recessed configuration of the outer rails 18, 18a allows the entire inner rail 27 to be disposed in and move in the outer rail inner housing recess 181 so that the drawer 2 engages with the metal housing 1. Then FIG. 28AA further describes the mounting procedure of the drawer 2 and the metal housing 1, wherein when the drawer 2 is pushed in, besides the key 40 is turned to allow the lock frame movable lock bar 160 to ascend, the guide rail end movable piece 289, 229 needs to be turned to a position wherein the movable piece is in alignment with the movable lock bar guide rail 218, 228 so that said lock frame movable lock bar 160 can smoothly enter and run through the movable lock bar guide rail 218, 228 to finish the assembling. Now referring to FIG. 28BB-FIG. 28CC, the hanger mounting lug 281 outwardly protruding from the left and right ends of the transverse hanger 28 is inserted into said hanger mounting gap 210, 220 so that the transverse hanger 28 is mounted on the top portion of the drawer 2. In addition, the longitudinal hanger legs 291 at the front and rear ends of the longitudinal hanger body 290 are mounted in the transverse hanger rail 283 so that the longitudinal hanger 29 can transversely slide along the transverse hanger 28. At last, other drawers 2 can also be mounted according to the procedures as illustrated in FIGS. 28R-FIG. 28DD so that the assembling of the entire metal storage cabinet can be finished to reach the use state as shown in FIG. 28EE.

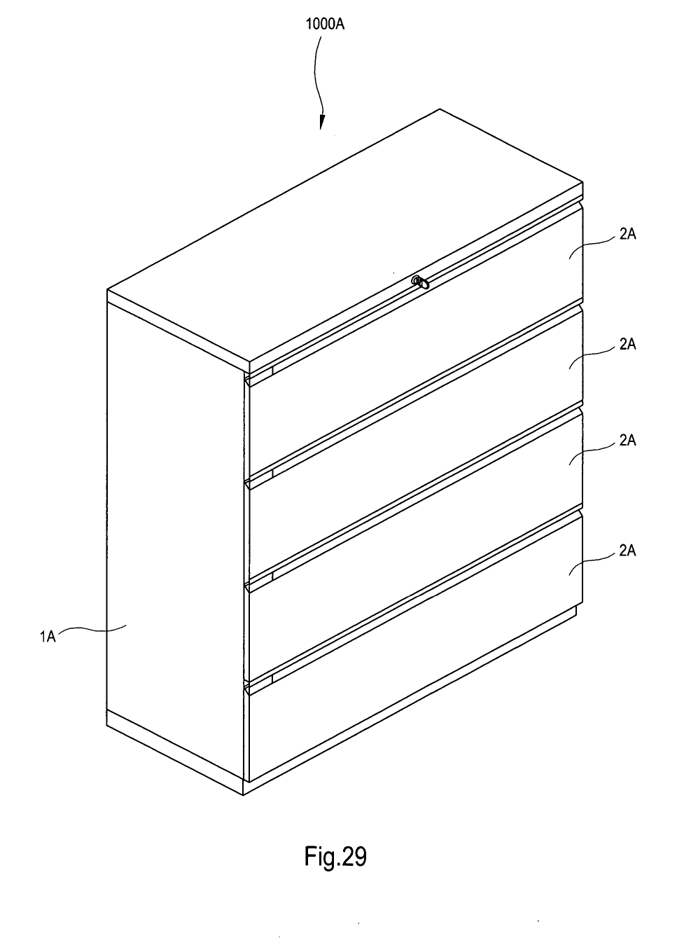

Finally referring to FIG. 29, the figure is a three-dimensional schematic view of the metal storage cabinet according to the second embodiment of the present invention. A metal storage cabinet 1000A according to the second embodiment can be obtained be only increasing or reducing the number of drawers 2A and the outer rails 18 and changing the number of the lock frame movable lock bars 160 on the lock frame movable lock rod 16, the outer rail stops 141 on the left and right sides of the lock frame 14, the outer rail snap holes 142, the lock fame recesses 143 and the outer rail snap holes 125, 135 on the left and right side panels 12, 13 and additionally by correspondingly enlarging or reducing the assemblies of the metal housing 1A.

It can be seen from the above structure that the present invention provides a novel design so that the present invention provides an assembleable and detachable metal storage cabinet 1000, that besides, a firm metal material is used, the entirely of the cabinet can be detached into parts of smaller sizes to be conveniently delivered into an office having a narrow doorway and then to be assembled again into a storage cabinet so as to overcome the conventional defect that a metal storage cabinet can be formed integrally only and the volume of the storage cabinet is to some extent limited or the defect that only a non-metal material such as fiberglass, wood or plastics can be used to the storage cabinet, wherein as such materials are not as firm as a metal, the resultant storage device deforms for lack of enough bearing force to support heavy files in the office and becomes not durable and so on.

1. An assembleable and detachable metal storage cabinet, characterized by comprising:
a metal housing holding a plurality of drawers, the metal housing comprising:
a base frame and four adjustable legs disposed on the bottom of the metal housing, the base frame having at each of the four corners a triangle metal plate adjustable leg threaded hole for screwing the adjustable leg in;
a rear panel on the back;
a left side panel on the left and a right side panel on the right, the right side panel being substantially the same as and disposed in mirror symmetry with the left side panel;
a welded structural lock frame disposed on the front side, the lock frame having on the left and right sides thereof a same number of outer rail stops, outer rail snap holes and lock frame recesses, the lock frame having at the central top position thereof a lock hole;
a lock catch movable connection shaft disposed in the top edge of the lock frame;
a lock frame movable lock rod disposed on the two sides of the lock frame;
a top cover located at the top portion of the metal housing;
a set of lock means comprising a lock head, a key, and a lock head retaining means;
a plurality of outer rails disposed on said lock frame and the left and right side panels; and
a plurality of drawers slidable in the metal housing, the drawer comprising:
a drawer bottom panel disposed on the bottom of the drawer;
a drawer left side panel located on the left of the drawer and a drawer right side panel located on the right of the drawer, the drawer right side panel being substantially the same as and disposed in mirror symmetry with the drawer left side panel;
a drawer rear panel disposed on the back of the drawer, the rear panel being of rectangular shape and having on the left and right sides a plurality of nail holes for connecting other drawer side panels;
a drawer front panel disposed on the front side of the drawer and assembled on the perimeter formed by an drawer right side panel outer edge, a drawer left side panel outer edge and a vertical edge of the drawer bottom panel;
a label disposed within a drawer handle;
an anti-collision rubber mounted in an anti-collision rubber snap hole;
a plurality of inner rails disposed on the drawer left and right side panels;
a plurality of transverse hangers disposed on the top portion of the drawer;
a plurality of longitudinal hangers disposed on the top portion of the drawer; and a plurality of cylindrical pulling peg.

2. The assembleable and detachable metal storage cabinet as claimed in claim 1, characterized in that a rear panel “U”-shaped edge at the left and right ends of the rear panel is like an asymmetrical “U” shape with the outwardly facing end being relatively shorter.

3. The assembleable and detachable metal storage cabinet as claimed in claim 1, characterized in that the left and right side panels respectively have rectangular left and right side panel bases and inwardly extending flanges, and the upper and lower flanges being provided with a plurality of screw holes, the inward edge extending to form a barbed shape, the panel base near the inner end being provided with a protruding platform on which are provided a plurality of outer rail snap holes, the base plate on the upper portion near the outer end being not provided with an inwardly extending flange to form a nick lock frame receiving opening, the tail portion of the outer end thereof extending to form a barb shape and form a flange on which are provided a plurality of left side panel recesses.

4. The assembleable and detachable metal storage cabinet as claimed in claim 1, characterized in that the outer rail stops each are a metal sheet at the inner edge of the two sides of the lock frame that can be raised.

5. The assembleable and detachable metal storage cabinet as claimed in claim 1, characterized in that the outer rail snap holes are holes at the inner edge of the both sides of the lock frame.

6. The assembleable and detachable metal storage cabinet as claimed in claim 1, characterized in that the central position of the lock catch movable connection shaft bends outwardly to form a protruding catch rightly concealed in a position in the interior of the lock hole, in that the two ends of the connection shaft both bend outwardly, and in that a plurality of rectangular retaining pieces are equally distributed between the middle portion of the connection shaft and the left and right ends of the connection shaft.

7. The assembleable and detachable metal storage cabinet as claimed in claim 1, characterized in that the lock frame movable lock rod is of a rectangular shape and provided with a plurality of lock frame movable lock bars which are fitted in said lock bar movement grooves and which number is the same as the number of the lock bar movement grooves, and in that the upper ends of the two movable rods engage with the left and right protrusions of the lock catch movable connection shaft.

8. The assembleable and detachable metal storage cabinet as claimed in claim 1, characterized in that a front flange of the top cover facing the front is in a “U” shape and provided at a central position thereof with a hole overlapping the lock hole of the lock frame.

9. The assembleable and detachable metal storage cabinet as claimed in claim 1, characterized in that the lock head is provided at the distal end with a lock head movable bar and located at one point of the circular perimeter.

10. The assembleable and detachable metal storage cabinet as claimed in claim 1, characterized in that the outer rails include two segments, and they are of an elongate and recessed configuration, in that the body of the outer rail inner housing is completely embedded in the recess of the outer rail outer housing, and in that the outer side of the outer rail is provided with two protruding outer rail snap bodies that are respectively tightly snap fitted with the outer rail snap holes on the lock frame and the left and right side panels.

11. The assembleable and detachable metal storage cabinet as claimed in claim 1, characterized in that the drawer bottom panel is provided at the front facing edge with a downwardly hanging vertical edge of the drawer bottom panel.

12. The assembleable and detachable metal storage cabinet as claimed in claim 1, characterized in that the bottom portion of the drawer left and right side panels extends inwardly, the rear end of the drawer left and right side panels extends towards the inner side and the front end of the drawer left and right side panels extends outwardly respectively to from an edge provided with a plurality of nail holes, in that the lower portion of the drawer left and right side panels is provided with a plurality of inner rail snap holes, in that an inner rail stop is provided at a middle position, in that a movable lock bar stop in an inverted right triangle is provided adjacent to a central position of the drawer left side panel base, in that an anti-collision rubber snap hole is provided above the movable lock bar stop, in that a movable lock bar guide rail is provided beneath the movable lock bar stop extending outwardly from the drawer left side panel, the guide rail extending from the front end to the rear end, in that a rotatable guide rail end movable piece is provided at the distal end of the movable lock bar guide rail, and in that the drawer left side panel is provided adjacent to the top edge with a plurality of upright hanger mounting gaps.

13. The assembleable and detachable metal storage cabinet as claimed in claim 12, characterized in that the inner rail stop is a metal sheet on the drawer left and right side panel bases that can be raised outwardly.

14. The assembleable and detachable metal storage cabinet as claimed in claim 12, characterized in that the head portion and the tail portion of the guide rail end movable piece body are respectively in rectangular and triangular shapes, and in that the central portion of the guide rail end movable piece body is provided with a movable piece axle hole acting as a central axis so that the guide rail end movable piece can be freely rotatable.

15. The assembleable and detachable metal storage cabinet as claimed in claim 1, characterized in that the perimeter of the drawer front panel is a two-layered metal sheet frame, in that the left and right edges thereof are provided with a plurality of screw holes, in that the upper edge of the metal sheet frame is provided on the outwardly facing side with a front panel recess that slants upwardly and inwardly in such a manner that the upper edge of the metal sheet frame forms a downwardly barbed shape.

16. The assembleable and detachable metal storage cabinet as claimed in claim 1, characterized in that the cross-sectional shape of the label is the same as that of the front panel recess.

17. The assembleable and detachable metal storage cabinet as claimed in claim 1, characterized in that the anti-collision rubber body is dimensioned in such a manner that an anti-collision rubber piece protruding from the outer end of the anti-collision rubber is disposed at an inward position on the left and right sides of the metal sheet frame.

18. The assembleable and detachable metal storage cabinet as claimed in claim 1, characterized in that the back side of the inner rail is provided with a plurality of inner rail snap bodies and an inwardly raised inner rail stop, and in that the inner rail is of an elongate recessed configuration and the entire inner rail can be assembled in the outer rail inner housing recess.
